(19) United States
(12) Patent Application Publication
(10) Pub. No.: US 2002/0052832 A1
(43) Pub. Date: May 2, 2002

(54) Electronic commerce method and system

(75) Inventors: Seiichi Itakura, Chiba-shi (JP); Toshiaki Kito, Chiba-shi (JP)

Correspondence Address: BRUCE LONDA, NORRIS, MCLAUGHLIN & MARCUS, P.A., 220 EAST 42ND STREET, 30TH FLOOR, NEW YORK, NY, 10017, US

(73) Assignee: Toyo Engineering Corporation, Chiba-ken (JP)

(21) Appl. No.: 10/007,386

(22) Filed: Oct. 22, 2001

(30) Foreign Application Priority Data
Oct. 27, 2000 (JP) P2000-328073
Apr. 9, 2001 (JP) P2001-267297

(51) Int. Cl. G06F 17/60

(52) U.S. Cl. 705/37

(57) ABSTRACT

A web server in a center device collects transaction conditions of materials via the Internet from a material-seller terminal which each of material sellers has, and the collected transaction conditions are assessed. Thereby, the best material-seller is selected, and sales conditions of the best material-seller selected are offered, via the Internet, to a material-buyer terminal which each of material buyers has. The material buyers buy desired materials via the Internet based on the sales conditions offered via the Internet.

### BACKGROUND OF THE INVENTION

1. Field of the Invention

The present invention relates to electronic commerce method and system for reselling, via the Internet, various materials (hereinafter, referred to as materials), such as general industrial items, which can be sold and bought by specifying the requirement without changing the supplier's specification, the design, etc. every item. More particularly, the present invention relates to electronic commerce method and system capable of easily and properly selling materials for construction and maintenance of the refinery and petrochemical plant, materials for construction of a building, office supplies, etc.

2. Description of the Related Art

In addition to widely-used simple materials, generally, the materials for construction and maintenance of the refinery and the petrochemical plant have no complicated specifications. However, for the above materials, technical requirements need to be specified to determine a unique specification.

The above materials are bought by properly collecting the quotation thereof. However, there are many items in the materials that the technical evaluation is difficult for purpose of the guarantee for quality and neither quotation nor inquiry can be determined without technical data base and experience.

In recent years, smaller engineering companies, construction companies, and companies which develop the foreign market, greatly demand the procurement of materials with low costs, and they potentially desire the development of new markets at home and abroad. However, in many cases, they use products, in the domestic market, with which they have been already familiar while they understand that the above conventional materials are expensive due to the specialty thereof. Further, due to problems such as the language barrier, the inexperience of working after ordering, e.g., transport business and customs clearance, it is difficult to procure the materials from the foreign countries.

The domestic infrastructure of the electronic commerce using the recent computer technology and the information technology is being improved. The environment for procuring the materials from domestic and foreign markets with low costs and high quality is being improved.

However, the current electronic commerce only uses electronic media, instead of media such as a letter, a telephone, and a facsimile. The working for ordering the material and the account therefor are only implemented via the Internet. The business know-how to determine the technical specifications of the materials and contract conditions is not provided. Therefore, the current electronic commerce is not so different from the conventional method for carrying out the business.

The current electronic commerce deals in no exhaustive materials for specific business in specific industry fields, such as the materials for construction and maintenance of the refinery and the petrochemical plant, whose specification and unit price are specified.

On the electronic commerce, a material buyer procures the material by implementing the conventional businesses such as the nomination of vendor, the preparation of the inquiry, the issue of the request for quotation, the expediting for the quotation, the evaluation of the quotation, the negotiation of price, the purchase order, and the logistics and schedule control after ordering, the payment. Obviously, the material buyer which does not know the practical business know-how cannot procure the materials. Further, the material buyer needs complicated management, e.g., the change of the electronic commerce for each required material or the change of bureau for the order.

The material buyer can procure the materials from the foreign countries on the electronic commerce, only when the following conditions are satisfied.

(1) The material buyer knows well the seller for supplying the material with low price, as well as its financial standing thereof and its business skill.

(2) The material buyer can describe the specification of the material which is required therefor, by a foreign language.

(3) The material buyer can describe the purchase condition of the material.

(4) The material buyer can negotiate with a foreign material-seller.

(5) The material buyer can implement the working after ordering.

The material buyer can procure the materials, such as the materials for construction and maintenance of the refinery petrochemical plant, from the foreign countries on the electronic commerce, only by exactly knowing the above business know-how to procure the material.

Conventionally, there are trading companies for transaction between the domestic buyers and the foreign sellers. However, these trading companies are only agencies of the foreign sellers. They can supply the materials having different specifications from the single material-seller and, on the other hand, cannot supply the materials having a unique specification from a plurality of material sellers.

Because the trading companies have no business know-how to hatch the specification of the material and the contract condition.

### SUMMARY OF THE INVENTION

Accordingly, it is an object of the present invention to provide electronic commerce method and system in which materials with high quality and low price can easily and properly be procured even if the material buyer does not have the business know-how to hatch the specification of the material and the contract condition.

According to a first aspect of the present invention, there is provided an electronic commerce method for reselling the materials via the Internet, comprising the steps of: by the contractor for designing and selling the material, determining, in advance, a general condition of each of exhaustive materials necessary for specific industrial fields based on contractor's business know-how to hatch specifications and transactions of the material; collecting the transaction conditions of the materials from a plurality of material sellers; selecting one best material-seller every material based on the collected transaction conditions; offering all of sales conditions of the selected best material-seller via the Internet; and, by the material buyer, buying a desired material via the Internet based on the sales condition offered via the Internet.

In the above-mentioned electronic commerce method, the technical specifications and the contract conditions of the material determined by using the contractor's business know-how concerning the technical specifications and the contract conditions are disclosed to many material buyers via the Internet. Thus, the material with high quality and low price can easily and properly be resold to even the material buyer which has never procure the material from foreign markets yet.

Preferably, the sales condition via the Internet may include not only the technical specifications and the contract conditions of the materials but also information on the unit-price of the material.

Preferably, the electronic commerce method may further comprise the steps of: by the contractor for designing and selling the material, specifying in advance, a requirement for a technical specification and a requirement for the transaction condition, concerning each item of the material; and selecting one best material-seller each item based on the specified requirement for the technical specification and the specified requirement for transaction condition, concerning each item of the material.

Preferably, the electronic commerce method may further comprise the steps: by the contractor for designing and selling the material, selecting material-seller candidates based on a transaction history and predicting the amount of an annually purchased material; presenting the amount of the annually purchased material to the material-seller candidates and requesting the offer of a carried-out technical specification of the material and of a carried-out transaction condition of the material; selecting one best material-seller based on a carried-out technical specification of the material and a carried-out transaction condition of the material, which are offered by the material-seller candidates in response to the request; and making a yearly contract of a material transaction with the selected best material-seller.

Preferably, the electronic commerce method may further comprise the steps: by the contractor for designing and selling the material, registering the material seller for the yearly contract, and the carried-out technical specification of the material and the carried-out sales condition of the material for transaction with the material seller; and performing a transaction with the material seller based on the registered content.

In the configuration, as compared with the case in which the material buyer solely purchases the material, an inexpensive unit-price can be set and the best material can stably be supplied with low costs from the best material-seller.

Preferably, the electronic commerce method may further comprise the steps of: by the contractor for designing and selling the material, offering the technical specifications and the sales conditions of various materials via the Internet; by the material buyer, selecting a desired material based on the technical specifications and the sales conditions of various materials, which are offered via the Internet; requesting, via the Internet, an quotation of the selected material to the contractor for designing and selling the material; by the contractor for designing and selling the material, estimating the material, in response to the request of the quotation of the material from the material buyer; offering the estimate concerning the material to the material buyer via the Internet; and by the material buyer, ordering the material to the contractor for designing and selling the material after checking the quotation offered thereby.

Preferably, in the electronic commerce method, the quotation is made by exchange converting the subtotal of the material and adding a resale fee to the subtotal of the material which is exchange converted.

In the configuration, the material buyer does not need to manage the exchange risk and, thus, the troublesome payment in a plurality of currencies is prevented.

Preferably, the electronic commerce method may further comprise the step of: by the contractor for designing and selling the material, acting for a logistics and schedule control of the material after purchase order of the material buyer as an agent of the material seller.

Preferably, the electronic commerce method may further comprise the step of: by the contractor for designing and selling the material, offering, via the Internet, logistics information on the material after ordering, to the material buyer.

Accordingly, the material buyer which does not know the business know-how to procure the material from foreign markets well can easily procure the material and easily perform the processing after ordering the material.

According to a second aspect of the present invention, there is provided an electronic commerce system for reselling various materials via the Internet, comprising: a material-seller terminal connected to the Internet; a material-buyer terminal connected to the Internet; and a center device connected to the Internet, wherein the center device comprises: collecting means for collecting material transaction conditions, of the material seller, which are inputted by the material-seller terminal; selecting means for selecting a best material-seller based on the material transaction conditions which are collected by the collecting means; and offering means for offering a sales condition of the best material-transaction condition which is selected by the selecting means to a material seller via the Internet, and the material buyer buys a desired material via the Internet based on the sales condition which is offered via the Internet by the offering means.

Preferably, in the electronic commerce system, the selecting means may determine, in advance, requirements for a technical specification and requirements for a transaction condition, concerning each item of the material, and select the best material-seller every item based on the determined requirements for the technical specification and the determined requirements for the transaction condition with respect to each item of the material.

Preferably, in the electronic commerce system, the collecting means may comprise: candidate selecting means for selecting candidates of the material seller, which performs a transaction of the material based on a history; predicting means for predicting the amount of an annually purchased material; requesting means for presenting the amount of the annually purchased material, which is predicted by the predicting means, to the material-seller candidates selected by the candidate selecting means and requesting the offer of a carried-out technical specification of the material and a carried-out transaction condition of the material; and input means for inputting the carried-out technical specification of the material and the carried-out transaction condition of the material, which are offered in response to the requests of the requesting means by the material-seller candidates, and the selecting means selects the best material-seller from the material-seller candidates in accordance with an assessment, of the material-seller candidates, which the center device automatically performs or the contractor for designing and selling the material performs based on the carried-out technical specifications and the carried-out transaction conditions, of the material sold by the material-seller candidates, which are inputted by the input means.

Preferably, in the electronic commerce system, the offering means may comprise a specification database for storing specification information of the material which is sold by the best material-seller selected by the selecting means, and offer the specification information of the material stored in the specification database and the sales condition via the Internet.

Preferably, in the electronic commerce system, the center device may comprise: estimating means for accepting the request for quotation, which is inputted by the material-seller terminal, via the Internet and estimating the material which is designated by the material buyer in response to the accepted request for quotation; estimate offering means for offering the quotation made by the estimating means to the material-buyer terminal via the Internet; and order accepting means for accepting an order, of the material, which is inputted by the material-buyer terminal in response to the quotation offered by the estimate offering means.

Preferably, in the electronic commerce system, the estimating means may comprise: a unit-price database for storing unit-price information of the material; subtotal calculating means for calculating the subtotal of the material based on the unit-price information stored in the unit-price database and information on the purchased number of materials which is inputted by the material-buyer terminal; and resale total calculating means for calculating the resale total by adding a resale fee to the subtotal, of the material, which is calculated by the subtotal calculating means.

Preferably, in the electronic commerce system, the estimating means may comprise: an exchange conversion master for storing an exchange rate which is periodically updated; and exchange converting means for exchange converting the subtotal of the material, which is calculated by the subtotal calculating means, based on the exchange rate stored in the exchange conversion master and a payment currency which is designated by the material buyer.

Preferably, in the electronic commerce system, the estimating means may comprise: transportation cost calculating means for calculating a transportation cost required for transport from the material seller to the material buyer, based on the destination of the material which is inputted by the material-buyer terminal.

Preferably, in the electronic commerce system, the center device may comprise: managing means for acting for a management business of the material, after ordering, which is inputted by the material-buyer terminal as an agent of the material seller.

Preferably, in the electronic commerce system, the managing means may obtain management information of the material after ordering, from the material-seller terminal via the Internet, and offer the management information on the obtained material to the material-buyer terminal via the Internet.

Accordingly, in the electronic commerce method and system of the present invention, even if the business know-how to hatch the specification and the contract condition of the material is unknown, advantageously, the material with low-price and high quality can easily and properly be procured.

### BRIEF DESCRIPTION OF THE DRAWINGS

FIG. 1 is a diagram showing the structure of the overall electronic commerce system according to an embodiment of the present invention;

FIG. 2 is a flowchart showing in detail an example of seller selecting processing in a center device in the electronic commerce system shown in FIG. 1;

FIG. 3 is a flowchart showing in detail an example of material selling processing in the electronic commerce system shown in FIG. 1;

FIG. 4 is a flowchart showing an example of agency processing in the center device shown in FIG. 1;

FIG. 5 is a diagram showing an example of a material search screen in a buyer terminal provided for each of buyers;

FIG. 6 is a diagram showing logics for estimating the material found on the material search screen shown in FIG. 5;

FIG. 7 is a diagram showing an example of a preparation of inquiry screen in the buyer terminal provided for each of the buyers shown in FIG. 1;

FIG. 8 is a diagram showing an example of a transportation cost calculating screen when clicking a button for calculating a transportation cost on the preparation of inquiry screen shown in FIG. 7; and

FIG. 9 is a diagram showing an example of a quotation screen displayed when clicking an estimating button on the preparation of inquiry screen shown in FIG. 7.

### DESCRIPTION OF THE PREFERRED EMBODIMENTS

Hereinbelow, a detailed description is given of electronic commerce method and system according to an embodiment of the present invention with reference to the drawings.

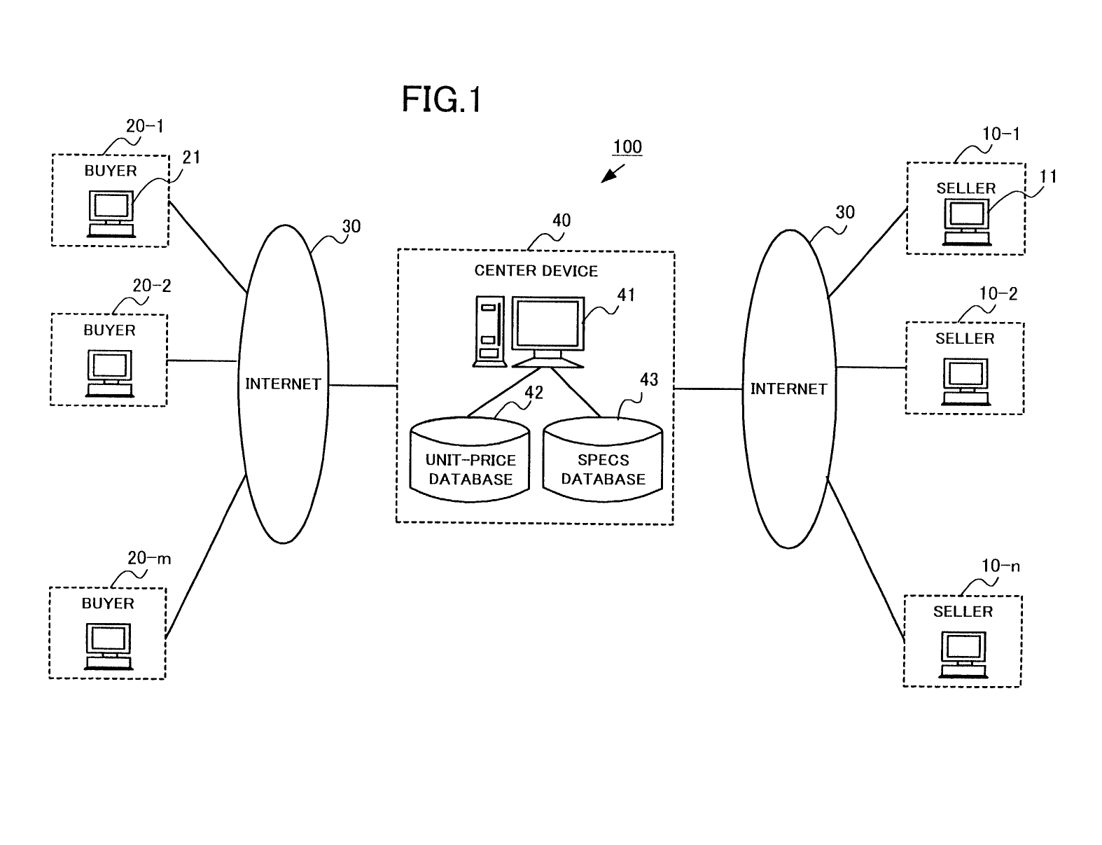

FIG. 1 is a diagram showing the overall structure of an electric commerce system according to the embodiment of the present invention.

Referring to FIG. 1, an electronic commerce system 100 is constructed via Internet 30. It is assumed that a variety of general materials used for the construction and maintenance of a refinery and a petrochemical plant are sold.

A variety of general materials used for the construction and maintenance of the refinery and the petrochemical plant contain piping materials, electrical equipment, electrical materials, instrumentation, instrumentation materials, and the like. Incidentally, the present invention is not limited to reselling a variety of general materials used for the construction and maintenance of the refinery and the petrochemical plant, and can be applied to reselling a variety of general materials in another industry which are equivalent to the various general materials used for the construction and maintenance of the refinery and the petrochemical plant.

In the electronic commerce system 100, material-seller terminals (hereinafter, referred to as seller terminals) 11 provided for material sellers (hereinafter, referred to as sellers) 10-1 to 10-n, serving as suppliers of sold materials and buyer terminals 21, provided for material buyers (hereinafter, referred to as buyers) 20-1 to 20-m to which the materials are supplied are connected, via the Internet 30, to a center device 40 for controlling the electronic commerce system 100.

Information is interchanged, via the Internet 30, between the seller terminals 11 and the center device 40 and between the buyer terminals 21 and the center device 40, respectively. Therefore, the seller terminals 11 and the buyer terminals 21 include personal computers accessible to the Internet 30 to which a www browser such as Internet Explorer or Netscape navigator is loaded.

That is, information is interchanged between the seller terminals 11 and the center device 40 and between the buyer terminals 21 and the center device 40 on the www browser.

Even if the buyers 20-1 to 20-m have no business know-how to hatch the specifications and the contract conditions of the materials, through the center device 40, they can easily and properly procure the materials with low price and high quality. The center device 40 deals in exhaustive materials of the construction and maintenance of the refinery and the petrochemical plant and, thus, the buyers 20-1 to 20-m can procure any desired material.

The center device 40 not only offers the list of materials but also assesses, in advance, the specifications and the contract conditions of the materials which are supplied from the sellers 10-1 to 10-n, selects, of the sellers 10-1 to 10-n, one best seller every material, and offers the carried-out technical specifications and the carried-out contract conditions such as sales conditions, unit prices of the materials which are offered by the selected best seller to the buyers 20-1 to 20-m. Thus, if the buyers 20-1 to 20-m have no business know-how to hatch the specifications and the contract conditions of the materials, the center device 40 can provide the best material with low price without complicated procedure.

The center device 40 comprises a web server 41 accessible to the Internet 30 similarly to the seller terminals 11 and the buyer terminals 21, a unit-price database 42 for storing unit price information of the materials, and a specification database 43 for storing technical information such as the specifications and the drawings of the materials.

In the electronic commerce system 100, the web server 41 in the center device 40 collects the transaction conditions of the materials via the Internet 30 from the seller terminals 11 of the sellers 10-1 to 10-n, and the contractor for designing and selling the material assesses the collected transaction conditions of the materials, thereby selecting the best seller. The sales condition offered by the selected best seller is offered to the buyer terminals 21 of the buyers 20-1 to 20-m via the Internet 30. The buyers 20-1 to 20-m purchase desired materials based on the sales condition offered via the Internet 30.

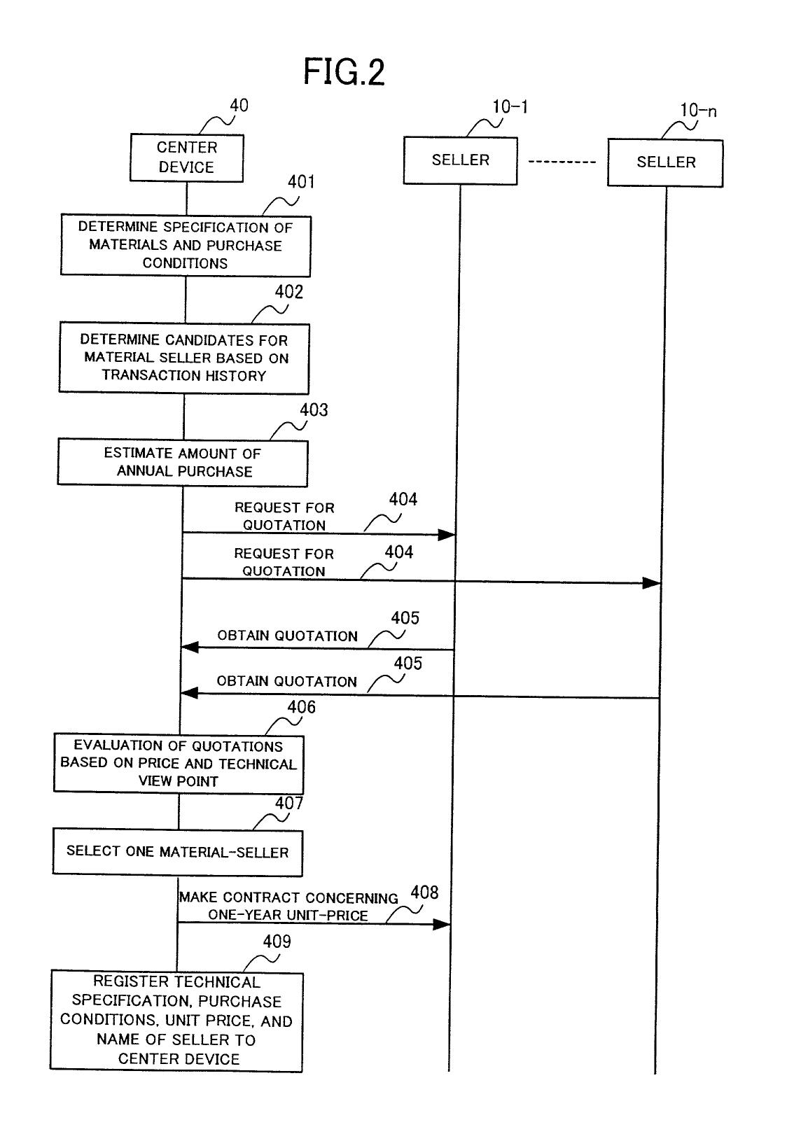

FIG. 2 is a flowchart showing in detail an example of seller selecting processing performed by the web server 41 in the center device 40 in the electronic commerce system 100 shown in FIG. 1.

Referring to FIG. 2, first, the web server 41 in the center device 40 determines the technical specifications and the purchase conditions of the materials which are sold (resold) (step 401). However, the technical specifications and the purchase conditions of the materials are complicated, the contractor for designing and selling the material determines the technical specifications and the purchase conditions of the materials.

If the general materials, including petroleum, used for the construction and the maintenance of the refinery and the petrochemical plant, the materials are exhaustively selected and the technical specification and the purchase condition are determined every material.

The web server 41 in the center device 40 determines seller candidates from the sellers 10-1 to 10-n whose technical specifications and purchase conditions of the materials match those in the determination in step 401, based on the transaction history (step 402). However, if the technical specifications and the purchase conditions of the materials are slightly complicated, the contractor for designing and selling the material determines the seller candidates from the sellers 10-1 to 10-n based on the transaction history.

The amount of annually purchased materials is predicted every material (step 403). The amount of annually purchased materials predicted in step 403 is indicated and the estimate including the unit price of each material is requested to the seller candidates selected from the sellers 10-1 to 10-n in step S402 (step 404).

In response to the request for the estimate, the estimate is obtained from the seller candidates among the sellers 10-1 to 10-n (step 405) and, then, the web server 41 in the center device 40 assesses the materials supplied from the seller candidates among the sellers 10-1 to 10-n based on the technique and the price of the materials (step 406). The web server 41 selects one of the seller candidates from the sellers 10-1 to 10-n, as a best seller (step 407). However, the contractor for design and selling assesses the material whose specification is complicated (step 406) and selects the best seller (step 407). Incidentally, FIG. 2 shows the case in which the seller 10-1 is selected as the best seller.

The buyers 20-1 to 20-m make contract concerning one-year unit-price of the supplied material with the one seller (seller 10-1) selected in step 407 (step 408).

The technical specification, the unit price, and the name of the best seller, as the seller 10-1, which supplies the materials and makes contract concerning the one-year unit-price of the material in step 408, are registered to the web server 41 in the center device 40 (step 409).

The unit prices of the materials registered in the web server 41 in the center device 40 are stored in and managed by the unit-price database 42 in the center device 40 shown in FIG. 1. The specifications and the drawings of the materials are stored in and managed by the specification database 43 in the center device 40 shown in FIG. 1.

Since the center device 40 selects the seller candidates from the sellers 10-1 to 10-n, which are determined based on the transaction history in step 402, it can safely and certainly select the seller candidate.

With respect to the selection of the seller candidate, the entire amount of annually purchased materials of the center device 40 is predicted (step 403). The predicted amount of annually purchased materials is indicated to the seller candidate and the estimate including the unit price is requested to the seller candidate among the sellers 10-1 to 10-n (step 404). Consequently, the unit price of the material can be reduced, as compared with a case in which the buyer purchases the material by itself from the seller.

As will be described hereinbelow, the information of the best seller selected by the center device 40 is indicated to the buyers 20-1 to 20-m. Thus, the buyers 20-1 to 20-m do not need to select the seller candidate. Even if the buyers 20-1 to 20-m have no business know-how to assess the specifications and the contract conditions of the materials, the materials can properly be procured with low price and high quality.

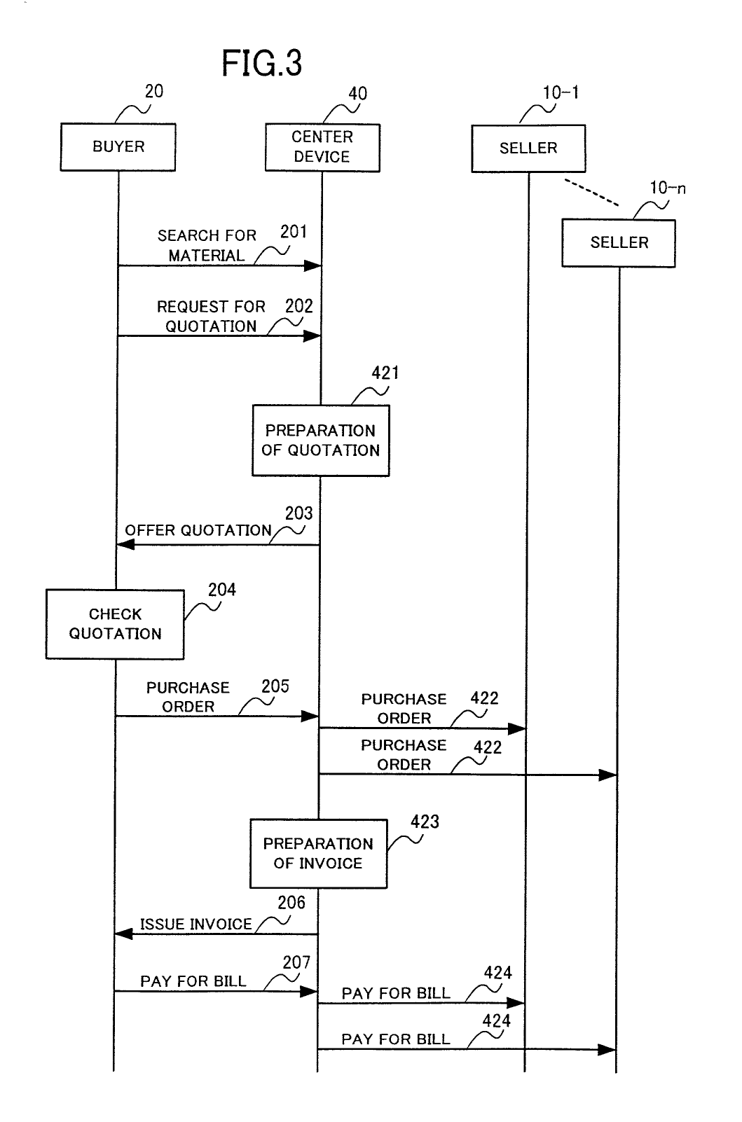

FIG. 3 is a flowchart showing in detail an example of material selling processing in the electronic commerce system 100 shown in FIG. 1.

The center device 40 in FIG. 1 stores the specifications, the drawings, the purchase conditions, and the like of the materials, which are determined in the processing in FIG. 2, in the unit-price database 42 and the specification database 43 in the center device 40 shown in FIG. 1.

Referring to FIG. 3, first, the buyer 20 which desires the purchase of an arbitrary material accesses the web server 41 in the center device 40 via the Internet 30 by operating the buyer terminal 21 thereof, and searches whether or not the desired material is registered in the unit-price database 42 and the specification database 43 in the center device 40 (step 201).

If the result in step 201 is YES, the necessary amount of the material is determined and the quotation is requested to the center device 40 (step 202).

The center device 40 receives the requests for the quotation from the buyers 20-1 to 20-m and, then, automatically draws up the quotation sheet by referring to various information in the unit-price database 42 and the specification database 43 (step 421). Although the processing for automatically drawing up the quotation sheet will be described in detail later, in this processing, the sub total is calculated based on the name of the material, the necessary amount of the material (the number of the material) informed by the buyers 20-1 to 20-m, and the unit-price information stored in the unit-price database 42. After that, if necessary, the exchange conversion is performed and the necessary resale fee is added, thus making estimate.

If necessary, the estimate includes the transportation cost.

The calculated estimate is indicated to the buyers 20-1 to 20-m via the Internet 30 (step 203).

The buyers 20-1 to 20-m check the content of the quotation indicated by the center device 40 in step 203 (step 204). If there is no problem in the quotation, the buyers 20-1 to 20-m order the material to the center device 40 via the Internet 30 (step 205).

If the center device 40 accepts the order from the buyers 20-1 to 20-m, it orders the material to the sellers 10-1 to 10-n as the suppliers which are registered in advance (step 422). In this case, the sellers 10-1 to 10-n are different sellers.

After ordering the material to the sellers 10-1 to 10-n, the center device 40 draws up the bill of the amount of money in the quotation sheet (step 423), and it charges the amount of money based on the bill to the buyers 20-1 to 20-m (step 206).

The buyers 20-1 to 20-m pay for the bill (step 207) and, then, the necessary amount of money is paid to the sellers 10-1 to 10-n from the buyers 20-1 to 20-m (step 424). In the configuration, for the buyers 20-1 to 20-m, the currency for payment and the payee have a single route, and the management and procedure for the payment can be simplified.

In the electronic commerce system 100 of the present invention, to simplify the processing of the buyers 20-1 to 20-m, instead of the material seller, the center device 40 performs the management business of the material after the buyers 20-1 to 20-m order it to the center device 40.

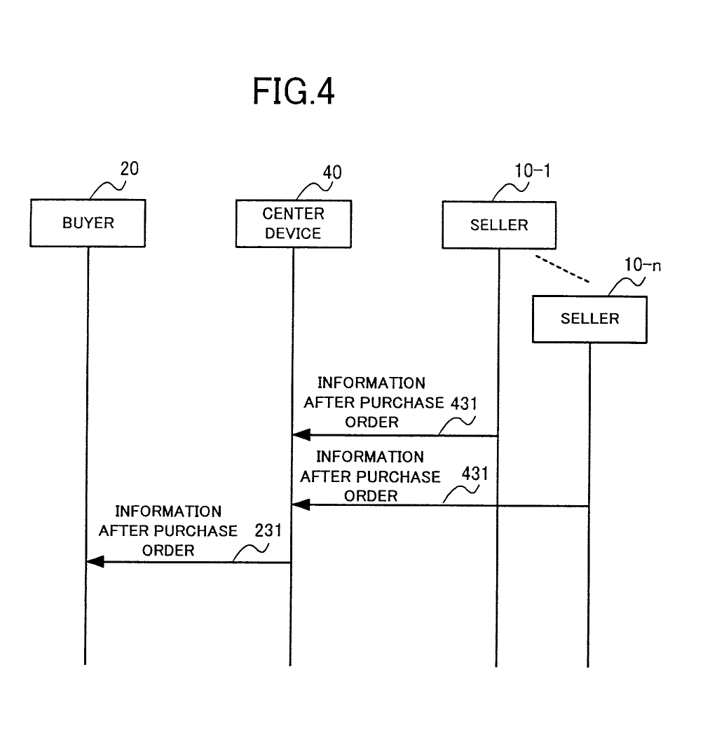

FIG. 4 is a flowchart showing an example of the agency processing of the center device 40 shown in FIG. 1.

After the buyers 20-1 to 20-m order the material to the center device 40, if any information after ordering is recognized in the sellers 10-1 to 10-n, the information after ordering is issued to the center device 40 from the sellers 10-1 to 10-n (step 431).

If the center device 40 receives the information after ordering, from the sellers 10-1 to 10-n, it issues the information after ordering, to the buyers 20-1 to 20-m as order sides of the material (step 231).

In the configuration, the buyers 20-1 to 20-m do not need to directly communicate with the seller and the operation for procuring the material is simplified for the buyers 20-1 to 20-m.

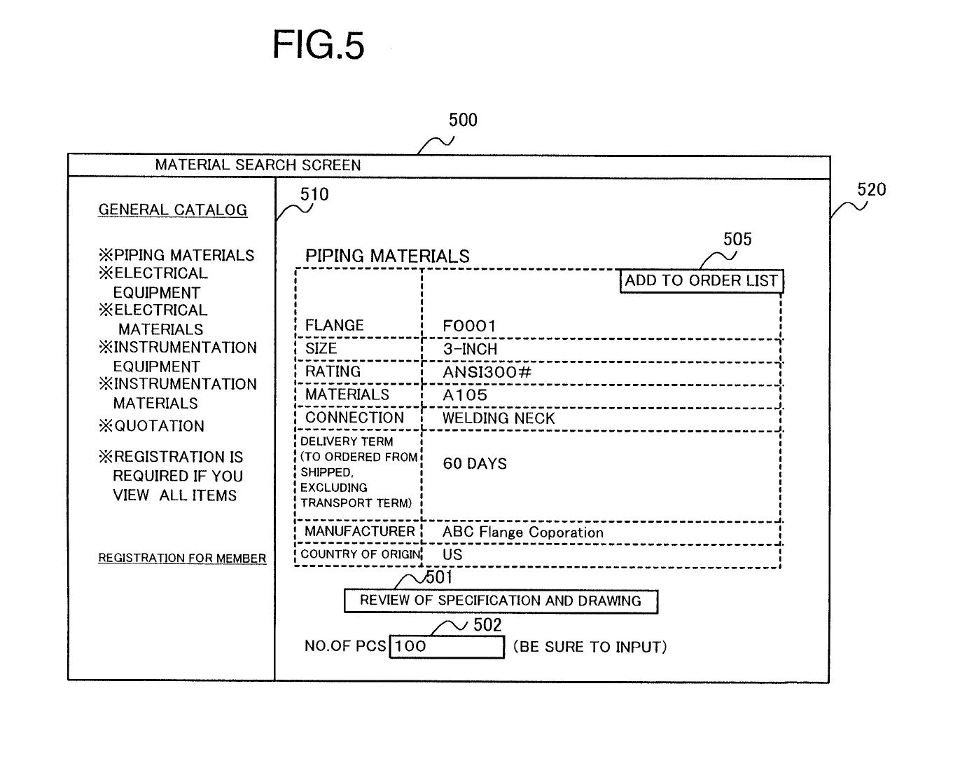

FIG. 5 is a diagram showing an example of a material search screen 500 in the buyer terminal 21 provided for each of the buyers 20-1 to 20-m.

Referring to FIG. 5, the general materials used for the construction and maintenance of a refinery and a petrochemical plant, are searched. The material search screen 500 is separated into a menu screen 510 of a union catalog and a search screen 520. By clicking characters in any of the following options of:

1) piping materials,

2) electrical equipment,

3) electrical materials,

4) instrumentation, and

5) instrumentation materials, the above materials can be searched.

Referring to FIG. 5, the piping material is selected. A serial-No. F0001 flange in the piping material is displayed.

The material search screen 500, with respect to the serial-No. F0001 flange, displays specification information such as size, rating, and connection, delivery term, name of a manufacturer, and a country of origin.

On the material search screen 500, a button 501 for referring to the specification and the drawing is linked, by a URL (Uniform Resource Locator), to the unit-price database 42 and the specification database 43 in the center device 40 shown in FIG. 1. By clicking the button 501 for referring to the specification and the drawing through a mouse (not shown), the material search screen 500 displays the specification or the drawing of the serial-No. F0001 flange, which are stored in the unit-price database 42 and the specification database 43.

In a frame 502 of the amount of purchase, the amount of the purchased serial-No. F0001 flange is inputted through a keyboard (not shown).

By clicking a button 505 for adding to an order list at the upper portion of a display frame of the search screen 520, 100 flanges of serial No. F0001 are added to the order list.

A portion composed of characters of “QUOTATION” on the menu screen 510 is clicked, thereby requesting, to the center device 40, the quotation of ordering 100 serial-No. F0001 flanges, displayed on the search screen 520.

A portion composed of characters of “REGISTRATION FOR MEMBER” on the menu screen 510 is clicked, thereby shifting to a sign-up screen for signing up for member. On the signup screen, necessary information is inputted, thereby performing sign-up for member.

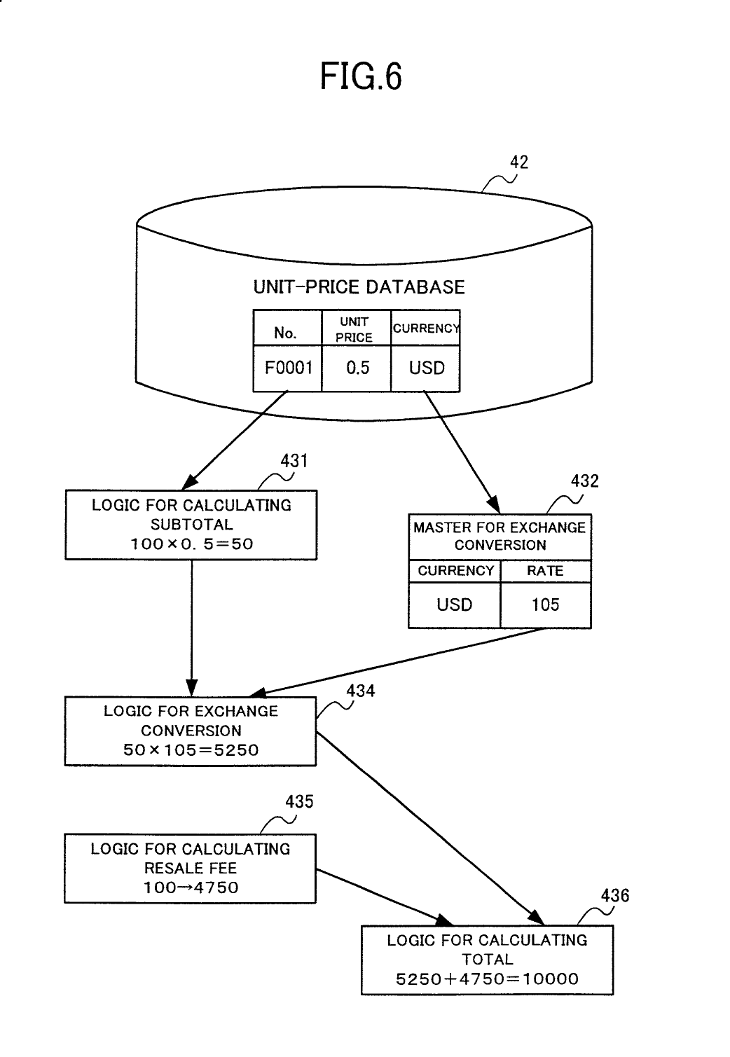

FIG. 6 is a diagram showing logics for estimating the materials found on the material search screen 500 shown in FIG. 5.

Referring to FIG. 6, the 100 serial-No. F0001 flanges are ordered on the material search screen 500 shown in FIG. 5.

The estimate in FIG. 6 is made based on the unit-price information stored in the unit-price database 42 in the center device 40.

The unit-price database 42 in the center device 40 stores a unit-price table 420 showing the unit price of the currency of the serial-No. F0001 flange.

In FIG. 6, the unit price of the serial-No. F0001 flange is 0.5 USD (U.S. Dollar)

In the logic for estimate shown in FIG. 6, first, in the logic 431 for calculating the subtotal, the subtotal of the 100 serial-No. F0001 flanges is estimated to be 50 USD by multiplying 0.5, as the unit price stored in the unit-price table 420 in the unit-price database 42, to 100, as the number of the purchased flange inputted in the frame 502 of the amount of purchase on the material search screen 500 in FIG. 5.

Simultaneously, an exchange conversion master 432 is started, thereby indicating that the exchange rate to 1 USD to Japanese Yen, stored in the unit-price table 420 in the unit-price database 42, is 105.

In a logic 434 for exchange conversion, the sub total 50 calculated in the logic 431 for calculating the sub total is multiplied to the exchange rate 105 to Japanese YEN obtained by the exchange conversion master 432, thereby exchange converting the subtotal 50 in the logic 431 for calculating the sub total.

In a logic 435 for calculating a resale fee, the resale fee is calculated by using the number 100 of the purchased flanges which is inputted in the frame 502 of the number of purchase on the material search screen shown in FIG. 5. In the case of the 100 serial-No. F0001 flanges, the resale fee is calculated at 4750 yen.

The logic 435 for calculating the resale fee may be performed in consideration for other conditions as well as the number of purchased materials.

In a logic 436 for calculating the total, the amount of money 5,250 yen, after exchange conversion in the logic 434 for exchange conversion, is added to the resale fee 4,740 yen in the logic 435 for calculating the resale fee, thereby obtaining 10,000 yen. Consequently, the total, including the resale fee of the 100 serial-No. F0001 flange, is calculated at 10,000 yen.

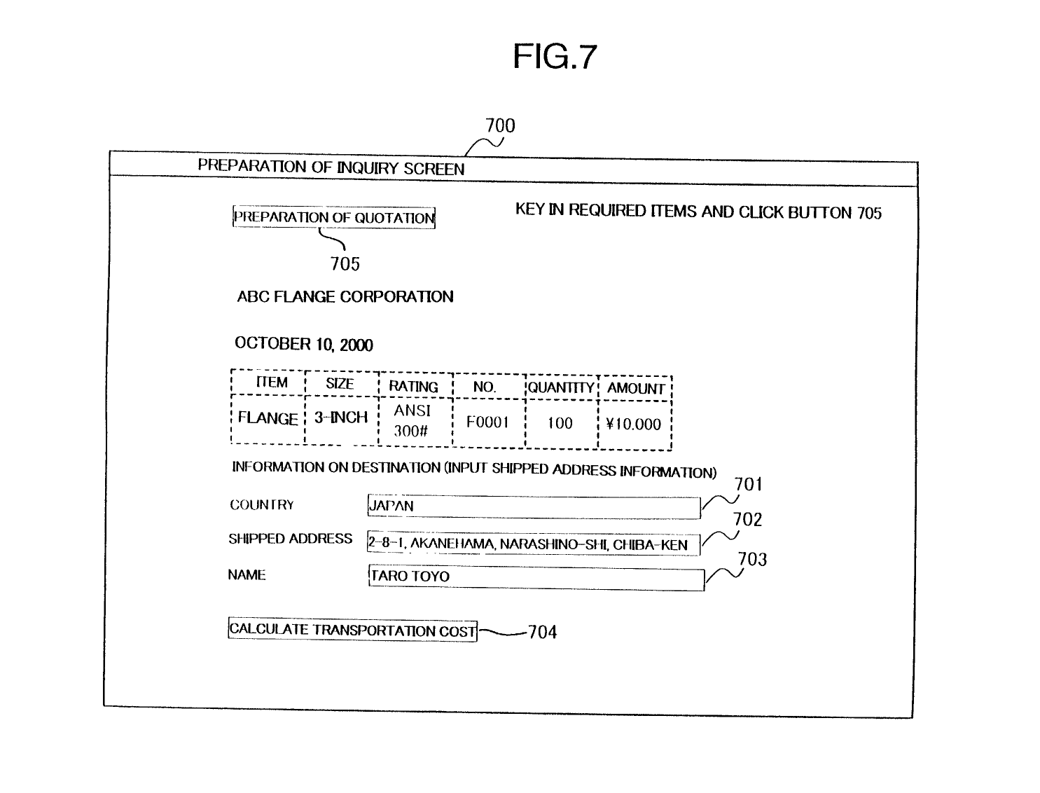

FIG. 7 is a diagram showing an example of a preparation of inquiry screen 700 in the buyer terminal 21 provided for each of the buyers 20-1 to 20-m shown in FIG. 1.

A portion composed of characters “QUOTATION” on the menu screen 510 shown in FIG. 5 is clicked, thereby shifting to the preparation of inquiry screen 700.

On the preparation of inquiry screen 700, information necessary for estimating the material found on the search screen 520 in FIG. 5 is inputted.

The preparation of inquiry screen 700 shown in FIG. 7 indicates an input screen when ordering the 100 serial-No. F0001 flanges on the search screen 520 shown in FIG. 5. The preparation of inquiry screen 700 contains the description in that the 100 serial-No. F0001 flanges are ordered, a country frame 701 for inputting the country name to which the material is shipped, a shipped address frame 702 for inputting the shipped address, and a person-in-charge name frame 703 for inputting the person-in-charge.

Necessary information is inputted, via a keyboard or the like (not shown), to the country frame 701, the shipped address frame 702, and the person-in-charge name frame 703 so as to request the estimate to the center device 40.

A button 704 for calculating the transport cost is clicked, thereby calculating the transport cost based on the information inputted to the country frame 701 and the shipped address frame 702 when transporting the 100 serial-No. F0001 flanges.

An preparation of quotation button 705 at the upper portion of the preparation of inquiry screen 700 is clicked, thereby requesting the estimate of the 100 serial-No. F0001 flanges to the center device 40.

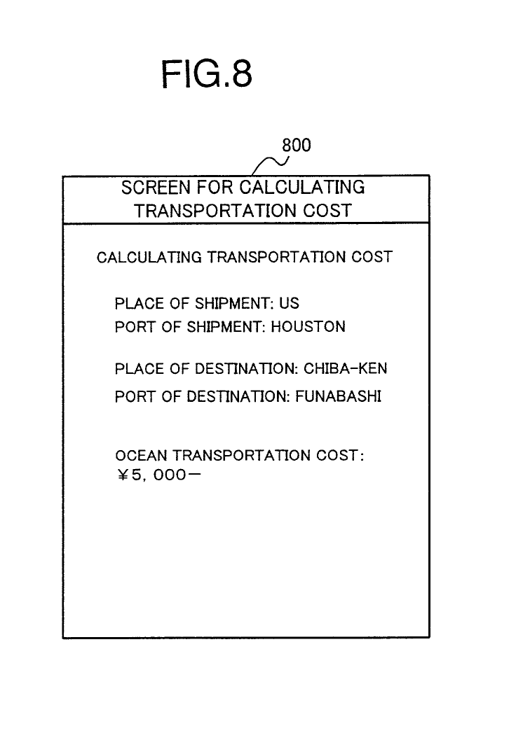

FIG. 8 is a diagram showing an example of a transport costs calculating screen 800 when clicking the button 704 for calculating the transport cost on the preparation of inquiry screen 700 shown in FIG. 7.

The transportation cost calculating screen 800 indicates an example of calculating the transportation cost when the 100 serial-No. F0001 flanges are ordered by inputting the necessary information on the preparation of inquiry screen 700 shown in FIG. 7.

Referring to FIG. 8, the place of shipment is U.S.A., the port of shipment is Houston, the place of reception is Chiba-ken, and the port of reception is Funabashi-shi. Thus, the ocean shipping cost is roughly calculated at 5,000 yen.

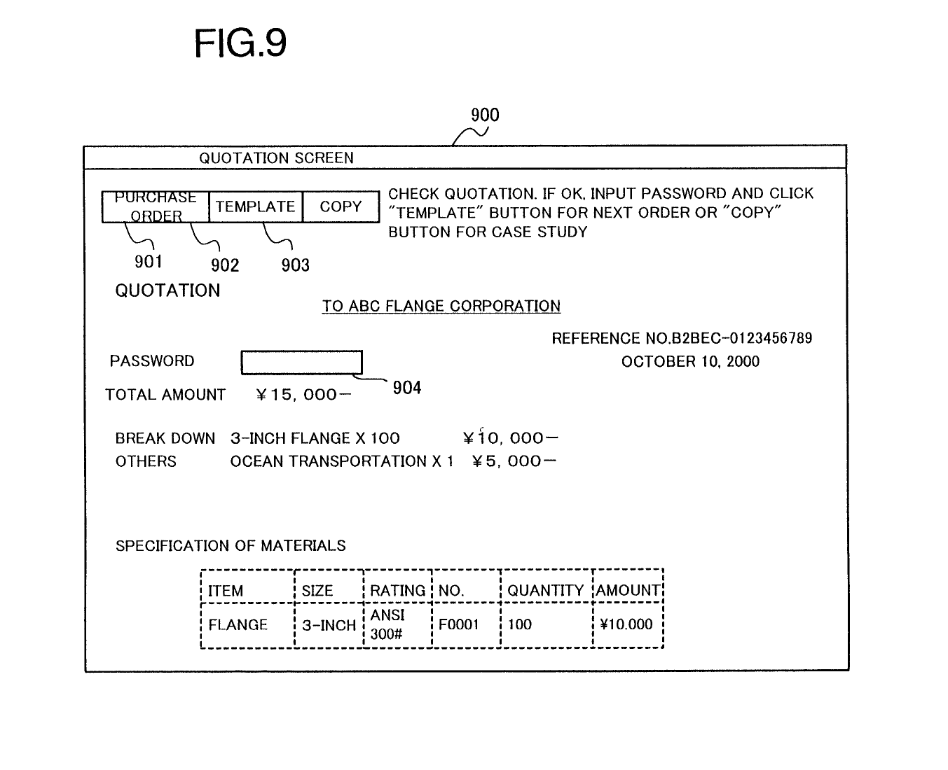

FIG. 9 is a diagram showing an example of an estimate screen 900 displayed when clicking the preparation of inquiry button 705 on the preparation of inquiry screen 700 shown in FIG. 7.

The estimate screen 900 is displayed through the web server 41 in the center device 40 based on the information inputted on the material search screen 500 in FIG. 5 and the preparation of inquiry screen 700 in FIG. 7.

On the estimate in FIG. 9, the price 10,000 yen of 100 sets of 3-inch flanges, the cost 5,000 yen of the ocean shipping cost, the specification of the materials, and the total sum 15,000 yen are described.

On the upper side of the estimate screen 900, an order button 901, a template button 902, and a copy button 903 are arranged. A password which is transmitted in advance for personal identification is inputted to a password frame 904. Thereafter, the order button 901 is clicked, thereby ordering the materials to the center device 40 with the content of the estimate. The template button 902 is clicked, thereby forming and storing estimate data when the materials are found.

The copy button 903 is clicked, thereby copying the estimate. Estimate data when the materials are found is formed and stored.

In the above configuration, it is possible to resell, via the Internet, the materials, of the specific seller, which are determined based on the business know-how regarding the method for specifying the technical specification of the material, the method for specifying the transaction condition, and the like, with the unit price based on information on the material seller which the material contractor for designing and selling the material has, the estimated amount of all-year purchase which is estimated by the material contractor for designing and selling the material. It is also possible to give the buyer, which has not purchased the materials from the foreign countries, opportunities to procure the materials from abroad with low price and high quality.

The buyer to procure the materials from abroad must form the English specification and the English transaction condition, by itself, manage the risk associated with the selection of the seller, and negotiate the price based on the amount of purchase of the single buyer. The buyer having no human resources capable of performing these businesses cannot procure the materials from abroad. However, in the present invention, since the contractor for designing and selling the material performs the complicated business in advance, the load when the buyer procures the materials from abroad can be greatly reduced.

Since the contractor for designing and selling the material negotiates the unit price of the procured material with the seller based on the estimated amount of annual purchase, it can obtain an advantageous condition, as compared with the case of the single-buyer's negotiation. The best resale-price can be set while adding the fee for the contractor for design and selling.

What is claimed is:

1. An electronic commerce method for reselling various materials via the Internet, comprising the steps of:
by a contractor for designing and selling the material,
collecting transaction conditions of the materials from a plurality of material sellers;
selecting the best material-seller based on the collected transaction conditions;
offering a sales condition presented by the selected best material-seller to a material buyer via the Internet; and
by said material buyer,
buying a desired material via the Internet based on said sales condition which is offered via the Internet.

2. An electronic commerce method according to claim 1, further comprising the steps of:
by said contractor for designing and selling the material,
specifying in advance, a requirement for a technical specification and a requirement for the transaction condition, concerning each item of the material; and
selecting one best material-seller for each item based on the specified requirement for the technical specification and the specified requirement for the transaction condition, concerning each item of the material.

3. An electronic commerce method according to claim 1, further comprising the steps:
by said contractor for designing and selling the material,
selecting material-seller candidates based on a transaction history and predicting the amount of an annually purchased material;
presenting the amount of the annually purchased material to the material-seller candidates and requesting an offer of a carried-out technical specification of the material and of a carried-out transaction condition of the material;
selecting one best material-seller based on a carried-out technical specification of the material and a carried-out transaction condition of the material, which are offered by said material-seller candidates in response to the request; and
making a yearly contract of a material transaction with the selected best material-seller.

4. An electronic commerce method according to claim 3, further comprising the steps:
by said contractor for designing and selling the material,
registering the material seller for the yearly contract, and the carried-out technical specification of the material and the carried-out sales condition of the material for transaction with the material seller; and
performing a transaction with the material seller based on the registered content.

5. An electronic commerce method according to claim 1, further comprising the steps of:
by said contractor for designing and selling the material,
offering the technical specifications and the sales conditions of various materials via the Internet;
by said material buyer,
selecting a desired material based on the technical specifications and the sales conditions of various materials, which are offered via the Internet;
requesting, via the Internet, a quotation of the selected material to said contractor for designing and selling the material;
by said contractor for designing and selling the material,
estimating the material, in response to the request of the quotation of the material from said material buyer;
offering the estimate concerning the material to said material buyer via the Internet; and
by said material buyer,
ordering the material to said contractor for designing and selling the material after checking the quotation offered thereby.

6. An electronic commerce method according to claim 5, wherein said quotation is made by exchange converting the subtotal of the material and adding a resale fee to the subtotal of the material which is exchange converted.

7. An electronic commerce method according to claim 5, further comprising the step of:
by said contractor for designing and selling the material, acting for logistics and schedule control of the material after purchase order of said material buyer as an agent of said material seller.

8. An electronic commerce method according to claim 7, further comprising the step of:
by said contractor for designing and selling the material,
offering, via the Internet, logistics information on the material after ordering, to said material buyer.

9. An electronic commerce system for reselling various materials via the Internet, comprising:
a material-seller terminal connected to the Internet;
a material-buyer terminal connected to the Internet; and
a center device connected to the Internet,
wherein said center device comprises:
collecting means for collecting material transaction conditions, of the material seller, which are inputted by said material-seller terminal;
selecting means for selecting a best material-seller based on the material transaction conditions which are collected by said collecting means; and
offering means for offering a sales condition of the best material-transaction condition which is selected by said selecting means to a material seller via the Internet, and
so that said material buyer may buy a desired material via the Internet based on the sales condition which is offered via the Internet by said offering means.

10. An electronic commerce system according to claim 9, wherein said selecting means has means for determining, in advance, a requirement for a technical specification and a requirement for a transaction condition, concerning each item of the material, and
has means for selecting the best material-seller for every item based on the determined requirement for the technical specification and the determined requirement for the transaction condition with respect to each item of the material.

11. An electronic commerce system according to claim 9, wherein said collecting means comprises:
candidate selecting means for selecting candidates of the material seller, which performs a transaction of the material based on a history;
predicting means for predicting the amount of an annually purchased material;
requesting means for presenting the amount of the annually purchased material, which is predicted by said predicting means, to the material-seller candidates selected by said candidate selecting means and requesting the offer of a carried-out technical specification of the material and a carried-out transaction condition of the material; and
input means for inputting the carried-out technical specification of the material and the carried-out transaction condition of the material, which are offered in response to the requests of said requesting means by said material-seller candidates, and
said selecting means selects the best material-seller from the material-seller candidates in accordance with an assessment, of the material-seller candidates, which said center device automatically performs or the contractor for designing and selling the material performs based on the carried-out technical specifications and the carried-out transaction conditions, of the material sold by the material-seller candidates, which are inputted by said input means.

12. An electronic commerce system according to claim 9, wherein said offering means comprises a specification database for storing specification information of the material which is sold by the best material-seller selected by said selecting means, and offers the specification information of the material stored in said specification database and the sales condition via the Internet.

13. An electronic commerce system according to claim 9, wherein said center device comprises:
estimating means for accepting the request for quotation, which is inputted by said material-seller terminal, via the Internet and estimating the material which is designated by said material buyer in response to the accepted request for quotation;
estimate offering means for offering the estimate made by said estimating means to the material-buyer terminal via the Internet; and
order accepting means for accepting an order, of the material, which is inputted by said material-buyer terminal in response to the estimate offered by said estimate offering means.

14. An electronic commerce system according to claim 13, wherein said estimating means comprises:
a unit-price database for storing unit-price information of the material;
subtotal calculating means for calculating the subtotal of the material based on the unit-price information stored in said unit-price database and information on the purchased number of materials which is inputted by said material-buyer terminal; and
resale total calculating means for calculating the resale total by adding a resale fee to the subtotal, of the material, which is calculated by said subtotal calculating means.

15. An electronic commerce system according to claim 14, wherein said estimating means comprises:
an exchange conversion master for storing an exchange rate which is arbitrarily updated; and
exchange converting means for exchange converting the subtotal of the material, which is calculated by said subtotal calculating means, based on the exchange rate stored in said exchange conversion master and a payment currency which is designated by the material buyer.

16. An electronic commerce system according to claim 13, wherein said estimating means comprises:
transportation cost calculating means for calculating a transportation cost required for transportation from the material seller to the material buyer, based on the destination of the material which is inputted by said material-buyer terminal.

17. An electronic commerce system according to claim 9, wherein said center device comprises:
managing means for acting for a management business of the material, after ordering, which is inputted by said material-buyer terminal as an agent of the material seller.

18. An electronic commerce system according to claim 17, wherein said managing means obtains logistics information of the material after ordering, from said material-seller terminal via the Internet, and offers the logistics information on the obtained material to said material-buyer terminal via the Internet.
